(19) United States
(12) Patent Application Publication
(10) Pub. No.: US 2014/0114018 A1
(43) Pub. Date: Apr. 24, 2014

(54) Molded Article

(71) Applicant: YAZAKI CORPORATION, Tokyo (JP)

(72) Inventor: Reizo Ito, Shizuoka (JP)

(73) Assignee: YAZAKI CORPORATION, Tokyo (JP)

(21) Appl. No.: 14/136,805

(22) Filed: Dec. 20, 2013

Related U.S. Application Data
(63) Continuation of application No. PCT/JP2012/066628, filed on Jun. 22, 2012.

(30) Foreign Application Priority Data
Jun. 22, 2011 (JP) 2011-138591

(51) Int. Cl. C08K 7/14

(52) U.S. Cl. CPC C08K 7/14
USPC 524/559

(57) ABSTRACT

The present invention relates to a molded article obtained by injection molding of a resin composition which comprises a thermoplastic polyester resin and a glass fiber and satisfies the following properties (1) and (2), wherein the molded article satisfies the following property (3): (1) the resin composition has a melt viscosity of 60 Pa·s or less at a temperature of 260° C. and a shear rate of 9700 sec⁻¹; (2) the resin composition has a crystallization temperature of 185° C. or higher at a temperature-lowering rate of −25° C./minute; and (3) the molded article has a bending strength-retaining ratio (%) of 85% or more when it is treated under conditions of 85° C. and 90% RH for 1,000 hours.

### CROSS REFERENCE TO RELATED APPLICATION

This application is a continuation of PCT application No. PCT/JP2012/066628, which was filed on Jun. 22, 2012 based on Japanese Patent Application (No. 2011-138591) filed on Jun. 22, 2011, the contents of which are incorporated herein by reference. Also, all the reference cited herein are incorporated as a whole.

### BACKGROUND OF THE INVENTION

1. Technical Field

The present invention relates to a molded article of a polybutylene terephthalate resin composition having excellent mechanical strength, impact strength, and fluidity and exhibiting little warp deformation. More specifically, it relates to a molded article of a polybutylene terephthalate resin composition which is most suitable for injection-molded articles for automobiles, such as a switch and a connector.

2. Background Art

Since thermoplastic polyester resins such as a polybutylene terephthalate resin (hereinafter also referred to as PBT) are excellent in moldability, mechanical properties, heat resistance, electric properties, and chemical resistance, they have been widely used in electric/electronic fields and automobile fields. Specifically, resin parts such as an automobile electric ignition coil and a stator core for micro motors may be mentioned. Particularly, as a connector of wire harness for automobiles, owing to good fluidity and excellent dimensional accuracy in addition to the aforementioned properties, the polybutylene terephthalate resin has been widely used in application uses such as an insert molded article and the like.

An insert molding method is performed for the purpose of reinforcing a desired resin part (resin molded article) or undercut molding and is an injection molding method of filling a part (insert) into the resin molded article. As the insert, in addition to parts of inorganic solids such as metals and metal oxides, organic solid parts such as wood parts and parts of thermosetting resins such as epoxy resins and silicone resins have been used.

In application uses to which the above method is applied, metal terminals such as a connector, metal-made bus bars composing electric circuits, various sensor parts, and the like have been usually disposed by press fitting or insert molding. Particularly, in application uses of parts to be mounted on automobiles, high durability under high-temperature and high-humidity environments or heat and cold cycling environments has been frequently required, and materials characterized by elastomers and/or various additives have been generally used.

However, the PBT resin has a low impact resistance and has a problem that it is prone to be cracked when impact is applied at assembling. For the purpose of improving mechanical properties, various reinforcing materials and additives have been blended into the PBT resin. In the fields where high mechanical strength and rigidity are required, it is known to use fibrous reinforcing materials including a glass fiber (GF) as a representative.

Moreover, it is devised to elevate molding temperature for the purpose of securing fluidity (PTL 1: JP-A-2007-112858 and PTL 2: JP-A-2009-155367).

### SUMMARY OF THE INVENTION

However, when a glass fiber is added in an amount of 30% by weight or more, conventional PBT materials exhibit no excellent fluidity and injection peak pressure becomes extremely high, so that defects such as shrinkage cavities and warps are frequently caused. Thus, the materials have a problem in moldability.

Moreover, in the technologies of PTL 1 and PTL 2, deterioration of the materials may advance and a possibility that durability may be adversely influenced increases.

With regard to the improvement in the fluidity of the PBT materials, there are already commercially available materials. However, they are standard grade products and, in the case of materials having added values such as hydrolysis resistance and heat shock resistance, high fluidity is not achieved and there is still a problem. Furthermore, solidification as a material is retarded by the addition of the aforementioned properties and thus much cooling time is required at molding. As a result, a molding cycle time is elongated and thus processing costs increase.

In molding of automobile parts, an object of the invention is to secure mechanical properties equal to or superior to those of conventional materials and also to enhance fluidity of a resin composition to improve moldability. Moreover, another object is to reduce processing costs by shortening the molding cycle time thereof.

The invention provides the following molded article.

[1] A molded article obtained by injection molding of a resin composition which comprises a thermoplastic polyester resin and a glass fiber and satisfies the following properties (1) and (2), wherein the molded article satisfies the following property (3):

(1) the resin composition has a melt viscosity of 60 Pa·s or less at a temperature of 260° C. and a shear rate of 9700 sec⁻¹;

(2) the resin composition has a crystallization temperature of 185° C. or higher at a temperature-lowering rate of −25° C./minute;

(3) the molded article has a bending strength-retaining ratio (%) of 85% or more when it is treated under conditions of 85° C. and 90% RH for 1,000 hours.

[2] The molded article according to the above [1], wherein the resin composition has heat shock resistance.
[3] The molded article according to the above [1] or [2], wherein the glass fiber is contained in an amount of 25 to 35% by weight in the resin composition.
[4] The molded article according to any one of the above [1] to [3], wherein the molded article is a connector.
[5] The molded article according to any one of the above [1] to [3], wherein the molded article is a housing of an electronic control unit.
[6] The molded article according to any one of the above [1] to [5], wherein the thermoplastic polyester resin is polybutylene terephthalate.

### Advantageous Effects of Invention

According to the invention, by enhancing fluidity of a resin composition, not only moldability is improved but also a cooling time of a molded article can be shortened, so that productivity can be remarkably enhanced. As a result, costs of an injection-molded article can be reduced.

### BRIEF DESCRIPTION OF THE DRAWINGS

FIGS. 1A, 1B and 1C are drawings showing a shape of the first test piece used in Examples, in which FIG. 1A is a top view of the first test piece, FIG. 1B is an A-A cross-sectional view of FIG. 1A, and FIG. 1C is a B-B cross-sectional view of FIG. 1A.

FIGS. 2A and 2B are drawings showing a shape of the third test piece used in Examples, in which FIG. 2A is a top view of the third test piece and FIG. 2B is a C-C cross-sectional view of FIG. 2A.

### DETAILED DESCRIPTION OF THE EXEMPLARY EMBODIMENTS

The followings will explain the resin composition to be used in the invention.

The thermoplastic polyester resin to be used in the resin composition of the invention is not particularly limited but is preferably a polyethylene terephthalate resin, a polybutylene terephthalate (PBT) resin, or the like and it is desirable to use a PBT resin.

The PBT resin to be used in the invention can be produced by polymerizing terephthalic acid and 1,4-butanediol as main raw materials. On that occasion, it is also possible to copolymerize other dicarboxylic acid or diol component according to need.

The dicarboxylic acid component other than terephthalic acid is not particularly limited and examples thereof include aromatic dicarboxylic acids such as phthalic acid, isophthalic acid, 4,4′-diphenyldicarboxylic acid, 4,4′-diphenyl ether dicarboxylic acid, 4,4′-diphenoxyethane dicarboxylic acid, 4,4′-diphenyl sulfone dicarboxylic acid, and 2,6-naphthalene dicarboxylic acid; alicyclic dicarboxylic acids such as 1,2-cyclohexane dicarboxylic acid, 1,3-cyclohexane dicarboxylic acid, and 1,4-cyclohexane dicarboxylic acid; and aliphatic dicarboxylic acids such as malonic acid, succinic acid, glutaric acid, adipic acid, and sebacic acid.

The diol component other than 1,4-butanediol is also not particularly limited and examples thereof include aliphatic diols such as ethylene glycol, diethylene glycol, polyethylene glycol, propylene glycol, 1,3-propanediol, polytetramethylene ether glycol, 1,5-pentanediol, neopentyl glycol, 1,6-hexanediol, and 1,8-octanediol; alicyclic diols such as 1,2-cyclohexanediol, 1,4-cyclohexanediol, 1,1-cyclohexanedimethylol, and 1,4-cyclohexanedimethylol; and aromatic diols such as xylylene glycol.

Terephthalic acid as one of the main raw materials preferably accounts for 80% by mol or more of the total dicarboxylic acid component and more preferably accounts for 90% by mol or more thereof. Moreover, 1,4-butanediol as one of the main raw materials preferably accounts for 85% by mol or more of the total diol component and more preferably accounts for 90% by mol or more thereof.

As a method for producing polybutylene terephthalate, there are a method through an ester exchange reaction of dimethyl terephthalate or the like with 1,4-butanediol and a method through a direct esterification reaction of terephthalic acid with 1,4-butanediol. According to the direct esterification reaction using terephthalic acid and 1,4-butanediol as starting materials, polybutylene terephthalate having a high melt crystallization temperature can be easily obtained as compared with the method through the ester exchange reaction.

Moreover, by conducting continuous polymerization, a high-quality resin can be obtained without a decrease in molecular weight, an increase in an amount of a terminal carboxyl group, and an increase in an amount of remaining tetrahydrofuran, which may result from a time lapse required for extraction from a reaction tank after completion of the reaction.

In the invention, the melt crystallization temperature is a value measured at a temperature-lowering rate of −25° C./minute on a differential scanning calorimeter and is a temperature of an exothermic peak owing to crystallization which appears when the resin composition is cooled at a temperature-lowering rate of −25° C./minute from a melted state thereof. The melt crystallization temperature corresponds to a crystallization speed and the higher the melt crystallization temperature is, the higher the crystallization speed is. When the melt crystallization temperature of the resin composition of the invention is 185° C. or higher, a cooling time can be shortened at injection molding and thus productivity can be enhanced. When the melt crystallization temperature is lower than 185° C., crystallization requires time at injection molding and thus the cooling time after the injection molding should be elongated, so that a molding cycle is extended and thus the productivity is lowered.

Furthermore, in order to suppress hydrolysis of the resin composition to be used in the invention, it is preferred to use a PBT resin having a terminal carboxyl group concentration of 30 mmol/kg or less. The case of controlling the terminal carboxyl group concentration to 30 mmol/kg or less is preferred since an amount of additives can be reduced. Incidentally, the lower the terminal carboxyl group concentration is, the more the amount of the additives can be reduced, so that the case is preferred.

From the viewpoint of hydrolysis resistance, the PBT resin composition to be used in the invention preferably has a terminal carboxyl group concentration of 20 mmol/kg or less.

The terminal carboxyl group concentration can be determined by dissolving a PBT resin in an organic solvent and titrating the solution using an alkaline solution.

A polymerization method for producing the PBT resin is not particularly limited but the polymerization is preferably carried out continuously using a serial continuous tank reactor. For example, a dicarboxylic acid component and a diol component are esterified at a temperature of preferably 150 to 280° C., more preferably 180 to 265° C. under a pressure of preferably 6.8 to 133 kPa, more preferably 9 to 100 kPa under stirring for 2 to 5 hours in the presence of an esterification reaction catalyst, the resulting oligomer as an esterification reaction product is transferred to a polycondensation reaction tank, and a polycondensation reaction can be carried out at 210 to 280° C. under a reduced pressure of preferably 30 kPa or less, more preferably 20 kPa or less under stirring for 2 to 5 hours in the presence of a polycondensation reaction catalyst in one or plural polycondensation reaction tanks. Polybutylene terephthalate obtained by the polycondensation reaction is transferred from the bottom of the polycondensation reaction tank(s) to a polymer extraction die, is extracted in a strand form and, with water cooling or after water cooling, and is cut by a peletizer to form a granule such as a pellet.

The esterification reaction catalyst to be used in the invention is not particularly limited and examples thereof include titanium compounds, tin compounds, magnesium compounds, and calcium compounds. Of these, titanium compounds can be particularly preferably used. Examples of the titanium compounds to be used as esterification reaction catalysts include titanium alcoholates such as tetramethyl titanate, tetraisopropyl titanate, and tetrabutyl titanate; and titanium phenolates such as tetraphenyl titanate. With regard to an amount of the titanium compound catalyst to be used, for example, in the case of tetrabutyl titanate, it is used in an amount of preferably 30 to 300 ppm (weight ratio), more preferably 50 to 200 ppm (weight ratio) as a titanium atom based on theoretical yield of the PBT resin.

As the polycondensation reaction catalyst to be used in the invention, the esterification reaction catalyst added at the esterification reaction can be continuously used as the polycondensation reaction catalyst or a catalyst the same as or different from the esterification reaction catalyst added at the esterification reaction can be further added. For example, in the case where tetrabutyl titanate is further added, an amount thereof is preferably 300 ppm (weight ratio) or less, more preferably 150 ppm (weight ratio) or less as a titanium atom based on theoretical yield of the PBT resin. As a polycondensation reaction catalyst different from the esterification reaction catalyst, for example, there may be mentioned antimony compounds such as diantimony trioxide, and germanium compounds such as germanium dioxide and germanium tetraoxide.

Next, the followings will explain the glass fiber to be contained in the resin composition.

In the invention, the glass fiber to be contained in the resin composition preferably has an average fiber diameter of 5 to 25 μm, an average fiber length of 400 to 550 μm, and an aspect ratio of 16 to 110. Moreover, shapes such as a cylinder and a cocoon shape, length at the use for producing a chopped strand, a roving, and the like, a method for glass cut, and the like are not particularly limited. In the invention, the kind of the glass is not limited but an anticorrosive glass having a zirconium element in the composition is preferred.

Moreover, in the invention, for the purpose of improving interface properties between the glass fiber and the resin matrix, it may be possible to use a glass fiber surface-treated with an organic treating agent such as an aminosilane compound or an epoxy compound.

The content of the glass fiber in the resin composition is preferably 25 to 35% by weight, more preferably 29 to 31% by weight. When the content falls within the range, good mechanical strength and fluidity can be obtained and thus the case is preferred.

In the invention, an improvement of fluidity of the resin composition to be used is one characteristic feature. The fluidity can be reflected using melt viscosity under a condition at a certain piston flow shear rate as an index. The melt viscosity of the resin composition of the invention is based on ISO 11443 and is 60 Pa·s or less, preferably 50 Pa·s or less at 260° C. and a shear rate of 9700 sec⁻¹. Moreover, a lower limit thereof is preferably 25 Pa·s or more. When the melt viscosity of the resin composition falls within the above range, an injection peak pressure-reducing effect, i.e., fluidity is satisfactory and molding stability is also maintained, so that the case is preferred.

Moreover, in order to control the melt crystallization temperature of the resin composition to 185° C. or higher, it is preferred to blend a crystal nucleus agent such as talc. The amount of the crystal nucleus agent to be blended can be appropriately controlled depending on the diameter and kind of the crystal nucleus agent. In the invention, the melt crystallization temperature is a value measured at a temperature-lowering rate of −25° C./minute on a differential scanning calorimeter.

Besides, the resin composition may contain an antioxidant, a UV absorbent, a photodegradation inhibitor, a thermal stabilizer, a releasing agent, a dispersant, a colorant, a flame retardant, and the like within a range where the effect of the invention is not impaired.

The PBT resin composition of the invention can be easily prepared by a conventional facility and a usual method. For example, use can be made any method, such as a method of preparing a pellet by knead-extrusion in a single-screw or twin-screw extruder after the components are mixed and then molding the pellet or a method of preparing pellets having different compositions once, mixing the pellets in prescribed amounts and subjecting them to molding, and obtaining a molded article having an objective composition after molding. Moreover, it is a preferable method for homogeneous blending of these components to mix and add a part of the resin components as a fine powder into the other component(s).

The molded article according to the invention to be obtained by molding the above resin composition has a bending strength-retaining ratio (%) of 85% or more, preferably 90% or more when the molded article is treated under conditions of 85° C. and 90% RH for 1,000 hours and a higher ratio is more preferable. When the ratio falls within the above range, remarkable molded article deterioration by hydrolysis can be suppressed, so that the case is preferred. The bending strength-retaining ratio can be determined according to the following equation from bending strength measured in accordance with ASTM D790 on the molded article before treatment and the molded article after treatment.

Bending strength-retaining ratio (%)=(Bending strength after treatment/Bending strength before treatment)×100

The resin composition of the invention can be molded by a usual molding method such as injection molding, blow molding, extrusion molding, compression molding, calender molding, or rotational molding to form a molded article, for example, for electric/electronic device fields, automobile fields, machine fields, medical fields, and the like. Particularly, since the productivity is improved by using the molding method through injection molding utilizing high fluidity that is a characteristic feature of the resin composition of the invention, it is industrially advantageous. At the injection molding, it is preferred to control a resin temperature to 240 to 270° C.

At the injection molding, for conducting insert molding using the PBT resin composition, as an insert, in addition to parts of inorganic solids such as metals and metal oxides, organic solid parts such as wood parts and parts of thermosetting resins such as epoxy resins and silicone resins can be used. These inserts have been commonly subjected to a treatment, for example, machine processing.

As a specific injection molding method, for example, a mold is first opened, the insert is fixed and then the mold is closed, and then the PBT resin composition of the invention is injected. Subsequently, after cooling, the mold is opened and an insert molded article is released from the mold. In order to perform adhesion by injection molding in a preferable state, it is preferred to bring the melted resin composition into contact with a surface to be adhered at a temperature as high as possible.

In the insert molding, it is generally sufficient to set a mold temperature at a range of 40 to 100° C. but, for improving adhesive strength, it is preferred to control the mold temperature higher. Moreover, since there is a case where release becomes difficult and thus molding becomes difficult depending on a cavity shape when the molding temperature is elevated, specifically, it is preferred to control the temperature to, for example, 50 to 80° C. For example, in the case where the mold temperature is set at a low temperature for shortening the molding cycle, it is also possible to enhance reactivity with the PBT resin composition of the invention by coating the insert before fixing with an adhesive or elevating temperature.

As a thin-wall molded article having a portion having a thickness of, for example, 1 mm or less at a part of the molded article, there may be exemplified injection-molded articles for automobiles, switches, condensers, connectors, integrated circuits (IC), relays, resistors, light emitting diodes (LED), coil bovines, electronic devices, portable terminals, ECU, various kinds of sensors, power modules, gear parts and peripheral devices or housings or chassis thereof, and the like.

As a molding method for filling the resin into the mold, injection molding, extrusion molding, compression molding, blow molding, vacuum forming, rotational molding, gas injection molding, and the like are applicable but injection molding is common.

Since the resin composition to be used in the invention has a low melt viscosity and a high melt crystallization temperature, it is applicable to various molded articles and, for example, is also suitable for injection-molded articles for automobiles, housings of various electronic devices, and the like. Particularly, the resin composition can be utilized for injection-molded articles such as switches, condensers, connectors, integrated circuits (IC), relays, resistors, various kinds of sensors, power modules, gear parts, and peripheral devices or housings or chassis thereof.

Incidentally, the connector in the invention represents not only one which is fitted to a terminal of an electric wire and connects an electric wire to another electric wire but also a broad sense “connector” such as a frontage of an electronic device or a terminal block and also includes one to which a metal is insert molded, such as a terminal or a collar. Moreover, a housing of an electronic control unit represents a control unit for performing electronic control, such as ABS or VSC and involves a circuit such as a bus bar or one to which a metal is inserted, such as a collar.

### EXAMPLES

The followings will explain the invention in detail with reference to Examples but the invention is not limited thereto.

### Examples 1 and 2, Comparative Examples 1 to 4

Blend materials used are as follows.

Thermoplastic polyester resin: the following polybutylene terephthalate resin compositions PBT-1 to PBT-6 were used.

PBT-1: (SF533AC: manufactured by Polyplastics Co., Ltd.)

PBT-2: (5108GF03: manufactured by Toray Industries Inc.)

PBT-3: (C7030LN: manufactured by Polyplastics Co., Ltd.)

PBT-4: (HR5330HF: manufactured by Du Pont de Nemours)

PBT-5: (5107G: manufactured by Toray Industries Inc.)

PBT-6: (B4300G6HS: manufactured by BASF Company)

Incidentally, the above polybutylene terephthalate resin compositions contain glass fiber in a ratio shown in Table 1.

Each pellet of the above resin compositions was dried for 3 hours in a hot-air drying chamber at 130° C.

Measurement of terminal carboxyl group concentration, melt viscosity, and crystallization temperature of the resin compositions were conducted according to the following methods.

### (Terminal Carboxyl Group Concentration)

Each pellet was weighed in an appropriate amount, dissolved in cresol under heating, and then cooled. The cooled solution was titrated with an alkaline solution to analyze an amount of COOH. The value shown here is acid concentration per 1 kg of the resin composition.

### (Melt Viscosity)

It was measured at a temperature of 260° C. at a shear rate of 9700 sec⁻¹ in a capillary of φ0.5 mm×10 mm in accordance with ISO 11443 using a capillograph.

### (Crystallization Temperature)

The melt crystallization temperature was measured at a temperature-lowering rate of −25° C./minute from 260° C. on a differential scanning calorimeter. Namely, there was measured a temperature of an exothermic peak owing to crystallization which appeared when polybutylene terephthalate was cooled at a temperature-lowering rate of −25° C./minute from a melted state.

### [Preparation of First Test Piece]

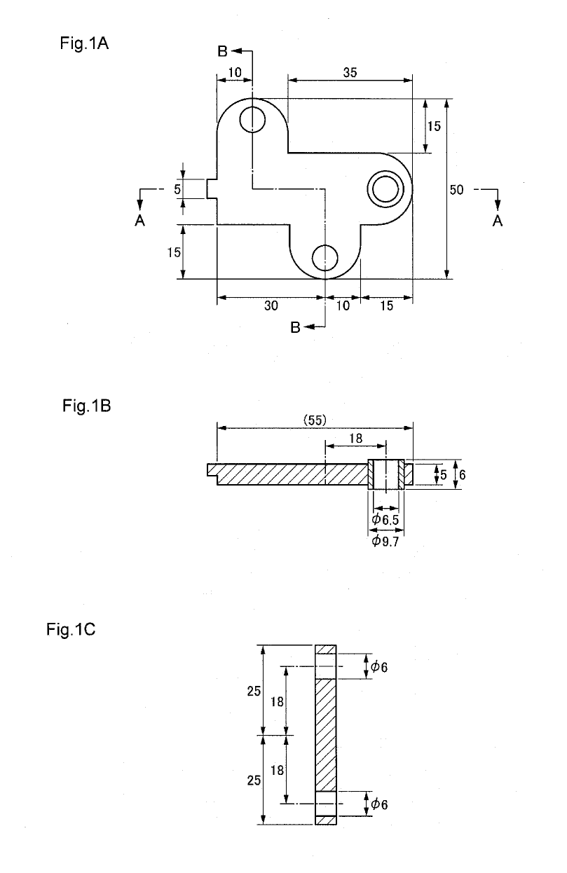

Next, each pellet was injection-molded at a set cylinder temperature of 250 to 260° C., at a set mold temperature of 80° C. and at an injection rate of 50 mm/s to prepare a first test piece having a shape shown in FIGS. 1A, 1B, and 1C. The obtained first test piece was evaluated for heat shock resistance by the following measurement method. Evaluation results are shown in Table 1.

### (Heat Shock Resistance)

Using a heat and cold impact testing machine, the first test piece (3 pieces each) was subjected to a heat shock resistance test in which a process of heating the test piece at 150° C. for 30 minutes, then lowering the temperature to −40° C. to cool it for 30 minutes, and further elevating the temperature to 150° C. was one cycle. The number of cycles until crack was generated in all the molded articles was measured to evaluate the heat shock resistance. The case where the resistance was superior to that of Comparative Example 1 in which PBT-3 as a standard material had been used was evaluated as good.

### [Preparation of Second Test Piece]

Next, each pellet was injection-molded at a set cylinder temperature of 250 to 260° C., at a set mold temperature of 80° C., at an injection rate of 50 mm/s to prepare a second test piece having a thickness of 1.6 mm defined at ASTM0790. The obtained second test piece was evaluated for hydrolysis resistance (bending strength) by the following measurement method. Evaluation results are shown in Table 1.

### (Hydrolysis Resistance)

After the second test piece was treated under conditions of 85° C. and 90% RH for 1,000 hours, bending strength was measured on the sample before treatment and the sample after treatment. A bending strength-retaining ratio (%) was determined according to the following equation and used as an index of hydrolysis resistance. The bending test was conducted in accordance with ASTM D790 and measurement was performed.

Bending strength-retaining ratio (%)=(Bending strength after treatment/Bending strength before treatment)×100

### [Preparation of Third Test Piece]

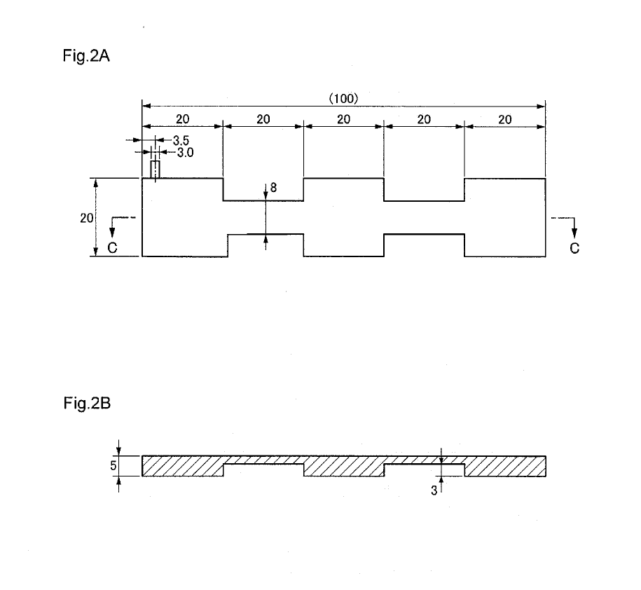

Next, each pellet was injection-molded at a set cylinder temperature of 250 to 260° C., at a set mold temperature of 60° C. and at an injection rate of 50 mm/s to prepare a third test piece having a shape shown in FIGS. 2A and 2B. The obtained third test piece was evaluated for injection peak pressure and cooling time-shortening ability by the following measurement method. Evaluation results are shown in Table 1.

### (Injection Peak Pressure)

As the injection peak pressure, peak pressure when the cooling time was set at 10 sec was measured. Evaluation results are shown in Table 1. The value of Comparative Example 1 in which PBT-3 as a standard material had been used was designated as 100%.

### (Cooling Time-Shortening Ability)

For the cooling time-shortening ability, the shortest cooling time at which the product was able to be taken out without damage was taken as a basis. Evaluation results are shown in Table 1. The cooling time of Comparative Example 2 in which a hydrolysis-resistant material PBT-4 had been used was designated as 100%.

TABLE 1

| | | | | Comparative | Comparative | Comparative | Comparative |
|---|---|---|---|---|---|---|---|
| | | Example 1 | Example 2 | Example 1 | Example 2 | Example 3 | Example 4 |
| Polybutylene terephthalate | | PBT-1 | PBT-2 | PBT-3 | PBT-4 | PBT-5 | PBT-6 |
| Content of glass fiber | [% by | 30 | 30 | 30 | 30 | 30 | 30 |
| | weight] | | | | | | |
| Terminal carboxyl group | mmol/kg | 12 | 7 | 23 | 9 | 26 | 25 |
| concentration | | | | | | | |
| Melt viscosity | [Pa · s] | 46 | 45 | 72 | 66 | 98 | 58 |
| Crystallization temperature | [° C.] | 196 | 193 | 197 | 183 | 179 | 183 |
| Heat shock resistance | | good | good | — | good | good | bad |
| Hydrolysis resistance | [%] | 90 | 91 | 62 | 92 | 78 | 64 |
| (bending strength-retaining ratio) | | | | | | | |
| Injection peak pressure | [%] | 84 | 88 | 100 | 106 | 132 | 93 |
| Cooling time-shortening ability | [%] | 57 | 57 | 36 | 100 | 110 | 86 |

Since the resin composition of the invention has a low melt viscosity and a high melt crystallization temperature, it is applicable to many molded articles and is also suitable for injection-molded articles for automobiles, housings of various electronic devices, and the like. Particularly, the resin composition can be utilized for injection-molded articles such as switches, condensers, connectors, integrated circuits (IC), relays, resistors, various kinds of sensors, power modules, gear parts, and peripheral devices or housings or chassis thereof.

What is claimed is:

1. A molded article obtained by injection molding of a resin composition which comprises a thermoplastic polyester resin and a glass fiber and satisfies the following properties (1) and (2), wherein the molded article satisfies the following property (3):
(1) the resin composition has a melt viscosity of 60 Pas or less at a temperature of 260° C. and a shear rate of 9700 sec⁻¹;
(2) the resin composition has a crystallization temperature of 185° C. or higher at a temperature-lowering rate of −25° C./minute; and
(3) the molded article has a bending strength-retaining ratio (%) of 85% or more when the molded article is treated under conditions of 85° C. and 90% RH for 1,000 hours.

2. The molded article according to claim 1, wherein the resin composition has heat shock resistance.

3. The molded article according to claim 1, wherein the glass fiber is contained in an amount of 25 to 35% by weight in the resin composition.

4. The molded article according to claim 1, wherein the molded article is a connector.

5. The molded article according to claim 1, wherein the molded article is a housing of an electronic control unit.

6. The molded article according to claim 1, wherein the thermoplastic polyester resin is polybutylene terephthalate.
